(19) United States
(12) Patent Application Publication
(10) Pub. No.: US 2025/0384728 A1
(43) Pub. Date: Dec. 18, 2025

(54) A TAMPERPROOF VOTING MACHINE

(71) Applicant: Group Captain Syed Mohammed GHOUSE (VETRAN), Hyderabad (IN)

(72) Inventor: Group Captain Syed Mohammed GHOUSE (VETRAN), Hyderabad (IN)

(21) Appl. No.: 18/254,601

(22) PCT Filed: Nov. 29, 2021
(86) PCT No.: PCT/IN2021/051119

§ 371 Date: May 25, 2023

(30) Foreign Application Priority Data
Nov. 28, 2020 (IN) 202041051872

(51) Int. Cl. G07C 13/00

(52) U.S. Cl. CPC G07C 13/00

(57) ABSTRACT

A voting machine includes a voting machine unit (100) having a control unit (201) connected to a display (203), a touchscreen (205), a memory device ( ), and a printer (207). The printer prints (207) on a printable medium vote information (107) representing votes entered by voters using the touchscreen (205), the votes being input to the control unit (201) from the touchscreen (205) and the control unit (201) responding to the input votes to control the printing of the vote information (107) by the printer (207). The printable medium is a rol 1 of paper material of a predetermined width and the printer (207) prints successive ones of the vote information (107) adjacent one another along a length and across the width of the paper material. A camera (209) records an image of the vote information and the control unit (201) compares the image with the vote entered on the touchscreen (205) and cancels the entered vote when the image does not match the vote entered.

The Tamperproof Voting Machine (TPVM) is computerised device, that counts as it prints the votes cast on tapes as well as providing visual and computerised verification, while facilitating conduct of simultaneous elections across an entire region, with expeditious results.

### FIELD OF THE INVENTION

The present invention relates to electronic voting machines, in particular voting machines that print and count all the votes cast.

### BACKGROUND OF THE INVENTION

One of the major problems facing most of the democratic countries is the general lack of public confidence in the electronic voting machines. The main apprehensions are that, errors and/or frauds could occur at any stage of voting, from the time of casting the votes, storing of the data, its retrieval and vote counting. An article titled, “Why paper is considered state-of-the-art voting technology” (Brookings, by Raj Karan Gambhir and Jack Karsten), has highlighted such issues (ref. SAFE Act, USA).

### Outline of the Invention

The invention discloses ways and means of overcoming the challenges being faced by the state of the art voting machines and systems, while obviating the disadvantages of both.

The present invention is a computerised system that prints all votes cast or ballots, hereinafter termed as “Vote” or “Votes”, on printable media, such as paper. The votes are progressively printed, as symbols, codes, alpha numeric text, in any format desired, on continuous lengths of paper, in form of tapes, that are wound either as a single or plurality of rolls or reels and placed in sealed containers, that could be stored separately, for security.

Further, since printed votes are verifiable and secured, internet access would not compromise the fidelity of the Votes, while enabling better election management. The electoral roll also gets updated as people vote. It would also be possible to digitally verify the voters and Votes, along with declaring the results on the same day, thereby saving substantially on the operational costs.

The election data is published information and accessible to public through the internet and print. It contains a list of all those in a constituency entitled to vote, also known as the electoral roll. Each elector/voter is issued with an Elector's Photo Identity Card UNPER (Unified National Photo Electoral Roll), in India. It contains certain essential details of the voter, including an ID number, barcode and/or QR code. Other countries have different forms of identification.

The data in the electoral roll consists of the particulars of the contestants, including their names, symbols, unique identification numbers barcode or QR code and whatever other information considered necessary by the election authorities and saved, constituency wise, in discrete “Files” that have a unique identification number (ID) or code.

While voting, the voters would be able to visually identify the contestants by the means of identification, such as the names, photographs, symbols, etc., while symbols and codes would be machine read.

Internet access is mostly disallowed for voting machines, in order to prevent tampering with the software and/or data. Whereas, in the present invention, since votes are printed and not “saved” on computer memory, there would be nothing to hack. Whereas, tampering of the images is visually and electronically verifiable and detectable.

In view of the above arguments, the present invention has been an option to use the data from election websites and/or portals, for managing elections, while ensuring that the security and confidentiality of the Votes are not compromised.

The present invention is also designed to provide transparency, integrity, fidelity and accuracy in the voting process and counting of the ballots. Whereas, the safe guarding the printed ballots/Votes would be the responsibility of the authorities.

The above as well as other advantages of the present invention would become readily apparent to those skilled in the art from the following detailed description of a preferred system, when considered in the light of the accompanying drawings, as discussed below:

### BRIEF DESCRIPTION OF THE SYSTEM

Modes of Operation. The present invention has several modes of operation. The main modes are depicted or listed in figures, as under:

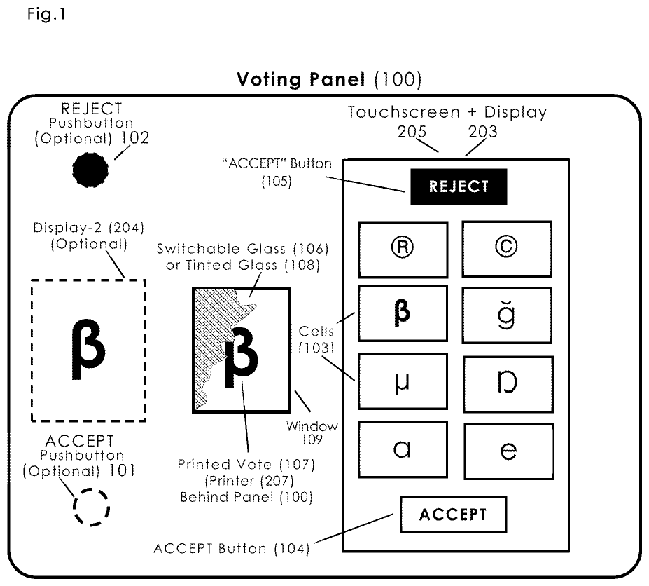

FIG. 1 Voting Machine Unit (VMU) 200 depicts a typical Voting VMU 200 Panel 100. The following components are shown:
Display Screen Display-1 203
Touchscreen 205
ACCEPT 101 and REJECT 102 Pushbuttons (Optional)
Cells 103
ACCEPT 104 and REJECT 105 Buttons
Transparent/Opaque “Switchable Glass” pane 106
Display-2 204 (optional)
Printed Vote 107
Alternatively, Tinted Glass pane 108
Window 108 for printer viewing printed vote
Window 109

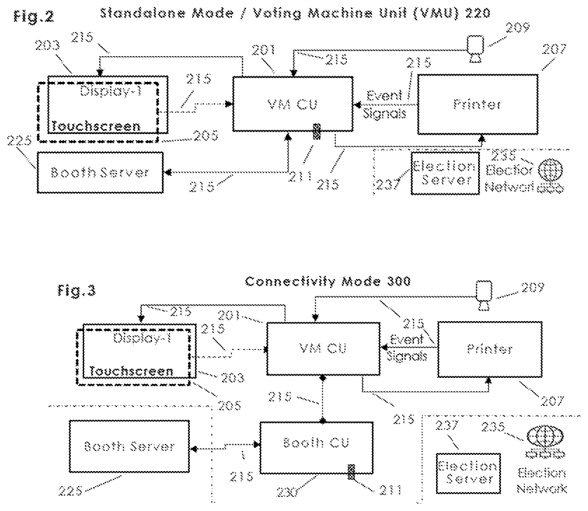

FIG. 2 Standalone mode 220,

FIG. 3 Connectivity Mode 300,

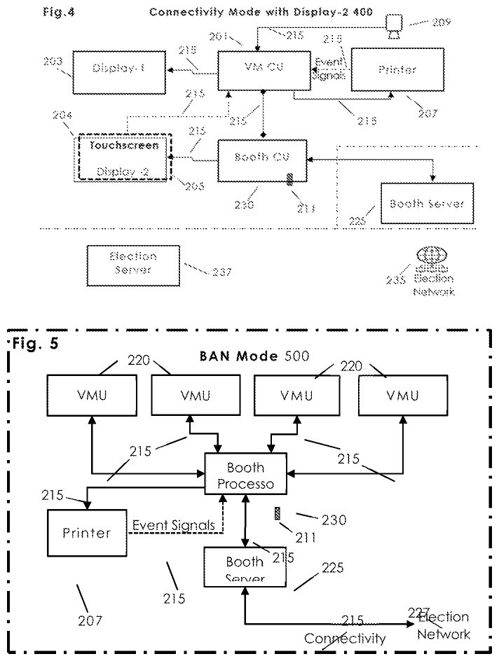

FIG. 4 Connectivity Mode with Display-2 400,

FIG. 5 BAN Mode 500.

Remote Access/Absentee Voting mode has a similar arrangement, except for some minor variations.

Modes of Operation. The present invention has several modes of operation. The main modes are depicted or listed in figures, as under:

FIG. 1 Voting Machine Unit (VMU) 200 depicts a typical Voting VMU 200 Panel 100. The following components are shown:
Display Screen Display-1 203
Touchscreen 205
ACCEPT 101 and REJECT 102 Pushbuttons (Optional)
Cells 103
ACCEPT 104 and REJECT 105 Buttons
Transparent/Opaque “Switchable Glass” pane 106
Display-2 204 (optional)
Printed Vote 107
Alternatively, Tinted Glass pane 108
Window 108 for printer viewing printed vote
Window 109

FIG. 2 Standalone Mode 220,

FIG. 3 Connectivity Mode 300,

FIG. 4 Connectivity Mode with Display-2 400,

FIG. 5 BAN Mode 500.

Remote Access/Absentee Voting mode has a similar arrangement, except for some minor variations.

### DETAILED DESCRIPTION

In the following paragraphs, certain Embodiments of the present are disclosed, followed by the specifications of the associated devices.

Standalone Mode: Voting Machine Unit (VMU), (200). This is the basic arrangement of the present invention. In this mode, the entire voting process can be performed without the voting machine communicating with any external source. Only the voters who are registered in a particular voting district or constituency can vote at the designated polling booths.

The heart of the voting machine is an embedded Processor board, herein termed as the Control Unit or “CU” 201, that is connected with the following main devices and components:
Display-1 203,
Touchscreen 205,
Printer 207 (direct thermal or thermal transfer printers have been considered as the preferred devices herein).
Camera 209.

Memory Devices, such as the SD Cards (not shown in the drawings). The VM CU 201 could have up to two Memory Devices, one of which being a template and back up. The Memory Devices contain the relevant particulars of all the contestants in the entire election area, sorted and numbered district/constituency wise.

The Memory Devices could also contain the ID numbers of the voters.

The Memory Devices could also have the Firmware, Software computer operating system, programs, applications and instructions for operating the components of VM CU 201.

Cables, Wires or connectors 215. All the connections are either through cables or wires and should preferably have Electromagnetic shielding, for preventing RF transmission through them. The arrowheads in the circuit indicate the direction of flow of signals or data.

A Printer 207 communicates event signals, such as PRINTING, PRINTED, PAPER JAM, UNSERVICEABLE, etc., to VM CU 201 and receives print commands from it.

Input Device. (FIG. 1) Even though various types of input or vote capturing devices are possible, such as keyboards, LCD/LED Tags, LCD/LED Keys, touchscreen is the preferred choice for the present invention.

Touchscreen Digitizer-Display. In an arrangement of the present invention, a touchscreen digitiser 205 and Display 203 could either be a single or two separate devices, with a common or individual connectors and cables, that are connected to either to one or two CUs, respectively.

A Display 203, displays the names, symbols and other necessary details of the candidates, on a table having rows and columns.

The format of the table being the same/standardised for an election.

The particulars of the contestants in the table could be automatically arranged, in a randomised order, each time a table is accessed.

VMU 200 Functioning. (Ref. FIG. 2). As a voter arrives to vote, the Voting Booth officials at a polling booth, having a The Booth Server 225, with means of communication with the Election Server 237, in Election Network 235, verify voters' identity, with the help of biometrics as well as any identification means available, for clearing or rejecting him/her to vote.

On acceptance of a voter to cast vote, a signal is sent to the VMU 200, through Cable 215, to commence a voting sequence on arrival of the voter at a VMU 200. The names and/or symbols of the contestants are displayed on Display-1 203 of the Voting Panel 100, (FIG. 1).

The voter makes his/her choice, that means Votes, by touching a Cell 103 on the Touchscreen 205.

A timer, set for the desired time, simultaneously starts a countdown.

The Vote is zoomed or highlighted on a Display 203 (FIG. 1), for better visual verification.

After a delay, a Printer 207 prints the Vote 107, which is observable through a window 109, with a Transparent/Opaque, Switchable Glass 106 fitted on the Printer Window 109, of Voting Panel 100, for final visual verification by the voter.

Whereas, if a thermal transfer printer 207 is used, instead of a direct printer, the printed areas on the ribbon become transparent and the printed matter can be seen.

As such, the ribbon also could be used as an evidence to the voting and for visual verification as well, instead of the paper tape.

A backlight is switched on, while a voting sequence is in progress, to make the image brighter, and is switched off thereafter. A tinted glass 108, instead of the Switchable Glass 106, on Printer Window 109 obscures the Vote, after the countdown.

A camera 209 attached on an upper side of the printed vote 107, captures an image of the printed vote 107.

CU 201 compares the selected and printed images and cancels the vote in case of disparity.

In case a voter had inadvertently made a wrong selection or the details displayed/printed are not as selected, the Vote can be cancelled by pressing the “CANCEL/REJECT” button, but within the countdown time. Thereafter, the vote would be irrevocably cast.

Once the countdown is over, the Switchable Glass turns opaque, obscuring the vote 107, and remains opaque till the next Vote is printed.

Touching Accept 105 buttons the terminates the countdown for that sequence and it skips to the next stage.

After further the countdown is over, the vote would be deemed cast,

Printer 207 then prints the progressive scores, in machine readable format, on the tape 107,

The votes are printed on one or a plurality of continuous lengths of paper tapes, that are wound on reels.

Scroll/Next Page. In case the number of contestants exceeds the number of rows, additional pages can be selected by pressing a “Next Page” key or by scrolling.

Screen Lock. A voter can cast vote only once. The Touchscreen 205 will become inoperative/Locked till such time it is reactivated by a polling officer, for the next voter or the vote is cancelled.

Camera. A Camera 209, attached on the printer, captures the printed Votes. The images are analysed by the CU. Since there would be only be a limited number of digitised and cataloged images, only a small area of an image would be sufficient for image recognition.

Alternatively, the camera 207 is attached in a front side of the Display-1 203. It captures a zoomed image of a voter's choice on Display-1 203 and prints it on the printer 207.

In yet another variation, a screenshot of the zoomed image is directly printed on the printer 207.

Optical Sensors for Printer. Instead of a camera, optical sensors could be used. The sensors are attached on top of the printer, at least one each on the edges of a tape and one in the center. The area under the sensors could be illuminated. Each image could be assigned a unique code, in form of a pattern of black and white squares or lines, printed on either edges of the tape. As images passes under the sensors, the black and white bits of the pattern are counted and the matching image identified.

Limitation—Standalone mode. Even though the data of all the contestants in an election entire area/country can be saved on the Memory Devices, thereby enabling any voters to vote from any polling booth/station, but it would not be possible to update the electoral roll without connectivity.

The subsequent inventions suggest certain ways and means of achieving it.

Simple VMU 200 Connectivity (FIG. 2). In this variation of the VMU 200, a means to transmit the IDs of the voters who have Voted has been additionally provided.

FIG. 2 also depicts a Global System for Mobile Communication (GSM) Dongle 211 (with SIM card), connected with a VM CU 201. As votes are cast, the IDs of each voter, in encrypted format, are messaged directly to an Election Server 237 in Election Network 235 and through the cable 215 to the Booth Server 225, thereby updating the electoral roll.

Booth Server 225 would have complete connectivity with the Election Network 235, including a SIM card/dongle 211, for receiving the IDs and acknowledgements, from VP VM CU 201 and Election Server 237, respectively.

In a version of this embodiment, the VMU 200 can only transmit the Codes, as messages, but has no reception capability.

In another version of this embodiment, the VMU 200 can transmit and selectably receive the Codes, as messages.

The rest of the procedure remains the same as for the “VMU 200 Functioning”, disclosed above.

It also maintains a record of the Votes and the respective acknowledgements.

The Votes could be randomly saved and the time of voting need not be recorded; in order to prevent associating the voters with their votes.

FIG. 3. Connectivity Mode 300, depicts another embodiment wherein, a CU, similar to the VM CU 201, termed herein as the “Booth CU” 230, has been added and connected with VM CU 201, through cable 215. CU 230 acts as a buffer between the VM CU 201 and the external sources, besides having some additional functions, as disclosed subsequently herein.

In this version, Dongle 211 is provided on the Booth CU 230, instead of VM CU 201.

In this mode any voter can vote from any polling booth/VMU 200. As a voter arrives to vote, the polling booth, the officials, besides verifying the voters' identity, also fetch the file code/number of the contestants from his/her constituency.

A signal, containing the file number of the respective voter's constituency, is sent to VM CU 201, by the Booth Server (225), through Booth Server Cable (215).

The VM CU (201) receiving the signal, fetches the names and/or symbols of the contestants from its Memory Device and displays the table on the Display 203 of the Voting Panel (100), (FIG. 1).

The rest of the components and operations remain almost the same as in the case of the embodiments disclosed above.

Further, since only codes would be transmitted, the rate and volume of the data transmission could be restricted, to preclude hacking.

Alternatively, the Cable 215 could have “Optical Transceivers” (not shown in the drawings), located at a joint, on cable 215. With optical Tr/Rx, communication between the two CUs would be through LEDs switching ON/OFF and optical sensor sensing it and the transmitting pulses, through cable/wire 215.

FIG. 4. Connectivity Mode with Display-2 400. This embodiment is similar to the Connectivity Mode 300, except for an additional Display-2 204.

In this embodiment, Touchscreen 205 is attached on Display-2 204, which is connected with the Booth CU 230 and Display-1 203 remain connected with the VM CU 201.

On receiving the constituency code of the voter who is to vote, from the Booth Server 225, Booth CU 230 fetches the corresponding file from a Memory Device and displays the names of the contestants on Display-2 204. It further communicates the file number to VM CU 201, either through cable 215 or the optical Tr/Rx.

The code could alternatively be displayed at a designated area on the Display-2 204. An optical sensor (not shown in drawings), attached on top of designated area, captures the code and communicates it to the VM CU 201.

The voter makes his/her choice, that means Votes, by touching a Cell 103 on the Touchscreen 205.

The coordinates of the selection are communicated by the Touchscreen to VM CU 201.

VM CU 201 fetches the selected candidate's particulars from a Memory Device and displays a zoomed image of it on Display-1 203, for visual verification by the voter.

The rest of the process remains the same as already described in connection with FIG. 3.

Connectivity Mode with Display-1. In this embodiment, the Display 203 has a switchable connection with VM CU 201 and Booth CU 230, through cable 215. Initially, cable 215 is connected with the Booth CU 230.

The rest of the connections are as in FIG. 3, Connectivity Mode 300.

On a voter Votes, the coordinates of the touchscreen are communicated to the VM CU 201, as in the case of FIG. 4. Connectivity Mode with Display-2 400.

The Display 203 connection 215 switches over to VM CU from Booth CU.

FIG. 5. BAN Mode 500. Booth Area Network (BAN). In case a polling booth has a plurality of voting machines, then a LAN could be created with plurality of VMUs 200, connected with a Booth CU 230, to form a Booth Area network, or “BAN”,

An additional Printer 207 could also be connected with Booth CU 230. The printer 207 prints all the votes cast at all the VMUs 200 in the BAN 500.

All the functions remain the same as in the rest of the embodiments already disclosed herein.

Since this mode has a plurality of VMUs 200, and the voters may be from different constituencies and would randomly get any VMU 200 to cast vote, it would be necessary to associate a VMU with the respective voter. Towards this, each voter could be given a printed code slip by the officials, such as the barcode or similar. Each200 VMU would have a code reader and would read the code and accordingly fetch the associated list of the candidates.

Further, each VMU 200 could also have a camera linked with a Biometric recognition means. The associated list of the candidates could be fetched, as in the case above.

Alternatively, the Booth Server 225 could allocate one of the VMUs200 to a voter and communicate the associated list of the candidates to a particular allocated VMU 200.

In all the embodiments disclosed herein, the VMUs can have no data communications with the external sources, except exchanging the file numbers of the candidates' files and the voters' details with the Booth CU 230 or only transmitting coded numbers through the Dongle 211.

Remote Access Voting/Absentee Voting Mode 245. In this mode, the absentee voters virtually access the touchscreen display on their computers or mobile phone, to vote.

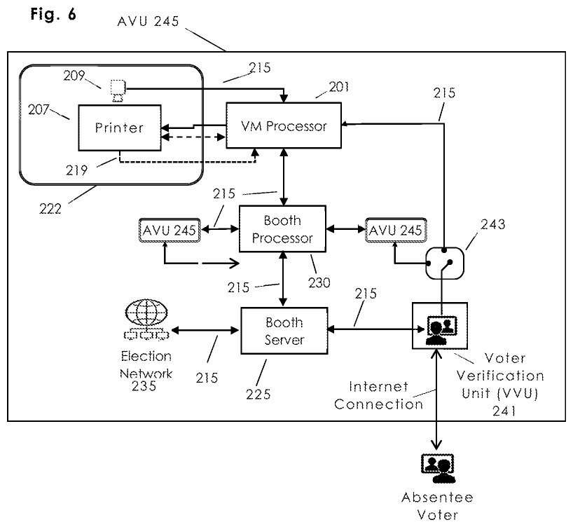

FIG. 6 depicts an Absentee Voting Unit 245 (AVU), that includes a VM CU 201, connected with a Printer 207 and Camera 209, with Printer 207 and Camera 209 being enclosed in a sealed container 222.

The VM CU 201 is connected with a Booth CU 230, which could optionally be connected with a plurality of AVUs 245s, and further with a Booth Server 225.

The Booth Server 225 is in communication with the Election Network 235 and at least one or a plurality “Voter Verification Unit” (VVU) 241 (only one VVU is shown in the diagram).

The VVU 241 could be manned by a team Election Officials, as in the case of a real Polling Station.

A VP VM CU 201 is also connected to a VVU 241, via Switch 243, through a cable 215. The absentee voters can connect with a VVU 241, through communication facilities such as the internet mobile network, and the like.

On connecting with a VVU 241, the voters are verified by the Election Officials and given access to an AVU 245, through Switch 243.

Once a voter is connected with a VM CU 201, the VVU 241 automatically gets disconnected.

The voter alone gets access to a Display, on his/her computer/mobile screen, similar to Display-1 203 and Touchscreen 205,

The voter makes a voting selection, either by touching a Cell 103 on its touchscreen or with a mouse on its display.

The voter would see the printed ballot/vote on his/her screen and as well be able to Reject or Accept the vote.

The whole voting process and arrangements of this associated devices therein, remain almost the same as in the case of the real system.

As can be appreciated from the forgoing that, the methods of communication between the VM CU 201, Booth CU 230 and the Booth Server 225, have been designed to make the remote voting process simple, secure and confidential.

Communication between the Booth Server 225 and Election Network 235. The Master Election Server marks the Voted names accordingly in the voters list and updates the rest of the Election Servers 237 in the Election Network 235 as well. In that way, the voters list is updated in the election area, consequently precluding the possibility of fraudulent voting.

The Booth Servers 225 are also updated by an Election Server 237.

Booth Server 225 saves the list of voters who have voted and also receive the corresponding acknowledgements in their memory. However, while updating the voter's list, the time of voting is not saved on any of the Election Servers 237 or Memory Devices, thereby providing confidentiality to the voters.

If a Voted Code is not acknowledged by an Election Server 237, the respective Booth CU 230 sends reminders to the Master Election Server, until such time an acknowledgement is received, else raises an “Ack. Failure” notification, for action by the election authorities.

The Booth Servers 225 would be managed by election officials. Since the Election Servers 237 have the voters' data, it can be used for biometric identification of the voters, as they present themselves for casting votes.

For communicating this information any suitable communication means could be used, such as the GSM. The amount of data in this case would minimal, including encryption, and the speeds too need not be high.

In areas where mobile network is not available, landline communication could be used.

In remote areas, where no data communication is available, only the Standalone mode 220 would have to be used.

Voters' Data. In India, there could be as many as 10,000 contestants for the general elections and as many for the state elections (that is, 20,000-25,000) and 910 to 915 million voters. On the Memory Devices, mainly the information that is to be printed, including images and text, need be saved. The layout would be according to the user requirements.

The data at the national electoral roll/register, has the names of all the voters, including certain personal particulars, with each voter having a unique identification number/ID.

Biometrics, including photograph, fingerprints, etc., would also be helpful in voter recognition, if linked with the electoral roll.

The particulars of the voters are grouped and saved in files, constituency/polling booth wise, with each file having a unique identification number/ID.

Digitisation and Recognition of Election Symbols. Election symbols could be cataloged in a standardised format, such as their size, resolution, minimum line thickness, orientation long the vertical and horizontal axes.

The election symbols could also be digitised, preferably as “Black and White”/monochrome images, such that they are distinct and easy to recognise visually and by electronic means as well.

Each image would have a unique digital signature by which it can be recognised.

Further, for image recognition, instead of scanning an entire image, only the area of at least one predefined rectangle, along the length of an image, could be analysed. The rectangle is divided into horizontal segments of equal dimensions and numbered along the length. Since there would only be a finite number of images, it is highly unlikely to find more than one image with the same pattern.

Besides the pattern, the size of number of black and white pixels in the rectangle could also be associated with each image.

In addition to this, each image could also be assigned unique code, such as a barcode, QR code that should preferably be printed along the borders of each image, as it would be suitable if optical sensors are used. It would make it possible to scan the codes and the rectangular areas in a single pass; as the paper moves while printing. However, optical sensors have not been shown in the images. Even if Cameras 209 are used, the same method would hold good.

### Networking

“Election Network 235”. A network of servers, herein termed as “Election Server 237” and Booth Servers 225, with a “Master Election Server” acting as a switch/Hub, could be created in an elections area, herein termed as the “Election Network 235”. Information on voter identification, Contestants and Votes would be exchanged in the network.

Communication between CUs. To prevent hacking, the size and rate of data transfer between the CUs, external devices and internet could also be restricted/choked to values that would be sufficient only for transmitting the codes, but not what is required for tampering, thereby precluding hacking.

Election data is accessed from the following sources:

Election Server 237 and temporarily stored thee volatile memory (in RAM) of the Booth Server 225 and or Booth CU 230.

The files having the Candidates' lists could even be downloaded on the volatile memory (RAM) of the Voting Booth, before commencement of the voting or if reboot is required and the connection disabled thereafter; to prevent further access to the outside servers.

Even in this case, the signals could be through alternative/unconventional means, such as optical transceivers, LEDs displaying codes, similar to the barcodes, and sensors/cameras that would receive the signals and transmit to the CU. Only cables or wires should be used. Notwithstanding, any other secure means of communication could also be employed. The transmission in a BAN is through shielded cables, for suppressing unwanted RF transmission.

Self-checks. The CU could be programmed to run periodic self-checks. In that, it would a sequence of votes will be printed and the results tallied. In case of a mismatch, an ERROR signal would be generated and voting for that machine suspended, till rectified. The self-checks would also be helpful during counting.

### Subsystems

Computerisation: Single-Board Computers (SBCS). Microprocessors, such as the Single-Board Computers (SBCS) and/or microcontrollers are considered suitable for the present invention. If necessary, regular computers could also be used. For convenience sake, the aforementioned devices are termed as the “Control Unit” or CU in this document.

Memory Devices. For data storage on the present invention, memory storage devices, such as the “One Time Programmable” (OTP) and/or “Write once read many” (WORM)” cards would be suitable.

Alternatively, data could also be saved on commercially available SD Cards and then the Tab be sealed in the “Locked” position, after the saving data.

Further, access can also be protected the by assigning passwords and employing other data security measures as well.

This would provide a higher assurance that the data has not been tampered with.

The present invention could have one, two or even no Memory Devices at all. In case of only one memory device, computer verification would be made between the selection on the Touchscreen and the printed Vote 107. There would be no template against which the authenticity of the Symbols and Codes could be checked.

To resolve this issue, a second Memory Device could be provided, as a template, for verification of the voters' choices vis-à-vis the Votes. In order to enhance the reliability factor, the data on the Memory Devices should be saved at two at different facilities, 50% at each. This would minimise the probability of both the batches of the Memory Devices being tampered with.

In another version of the present invention, there may either be no memory device or even if installed, election data may not be saved on it. In this case, the files of all the contestants would have to be downloaded from an election server before commencement of an election and preferably held in the volatile memory (RAM) of the Booth CUs 230.

Printer. Even though Inkjet or Laser printers could be used, but these machines require extensive modifications to suit the present invention as well a higher Operations & Maintenance and Capital expenditure.

Thermal printers, on the other hand, are better suited. They have fewer components and lower costs. As such, “Direct Thermal Printers” or “Thermal Transfer Printers” have been preferred for the present invention. However, any other type of printer could also be used, with suitable modifications.

The printer is mounted on a panel, in the same planes as the touchscreen-display, thereby making visual observation more convenient.

A printer is located in between the feeder and winder, with a paper tape passing through the printer

A reel feeder-receiver mechanism, with a paper tape or plurality thereof.

The two ends of a length the paper tape are attached and remain attached, reel-to-reel, throughout the voting process.

A printer can be installed on the tape without having to cut the tape.

The reel feeder-receiver mechanism can be attached without having to remove the printer.

Wherein, the reel is a hollow cylindrical tube of the length the same as that of the paper tape wrapped on it.

Wherein, the receiving reel is connected with a motor mechanism, controlled by the CU, synchronized with the printer motor rotation.

The Feeder reel maintains a tension on the paper, to keep is sufficiently under a tension.

As each ballot is cast, the printer prints the voter's choice and the progressive votes, in coded form, on the tape.

As each ballot is printed, the tape advances by one step, equal to the length of the printed matter, plus a margin.

The advancing tape is reeled in and wound on the reel winder.

The winder reels are encapsulated.

The tape is continuous, without a break.

The tape has only unidirectional motion, that is, from the feeder to the winder reel.

At the end on a voting session ballot tally is suitably printed on the tape for the respective voting machine.

The tallies are printed in a machine readable format.

To hide the tallied portion at the end of a tape, either an additional length of the tape is wound on the winder reel, till such time last tally print is covered by a blank portion of tape or the circumference of the cassette is wrapped around by an opaque tape and sealed.

The cassette is suitably sealed in both cases above.

The seals should be such that the tape should not be visible, accessible and rotatable. The seal would have to be broken to access the tape.

In order to access the printed tape from the cassettes, the seal would have to be broken.

Unauthorized breaking of the seal would render the tape invalid.

The feeder reel is designed such that it moves in one direction only, that is, it cannot be rotated in the opposite direction.

After a voting session is over, the winder reel, with the printed ballots, detached from the feeder reel for storage.

Printable Tape. The main distinctive feature of the present invention is the printable tape or ribbon. A tape of suitable width and length to record all the votes at a voting booth.

The Votes would be printed, preferably on plurality of paper tapes that would be wound on individual reels and could be stored separately. The essential information of the Votes would be sequentially printed on the tapes, without leaving gaps large enough to fraudulently print votes in between the printed ballots.

A plurality of tapes, each tape being the same, but a smaller width, such that the total width of the plurality of the tapes is the same as that of original paper width.

Wherein, the tapes of the smaller width are bunched together at the feeder end,

The feeder and receiving reels are mounted on a common shaft at each end.

The Votes for each contestant would also be progressively totaled and printed, in machine readable formats, similar to barcodes or QR codes. Hence, the Votes in favour of each candidate would be readily available, not only at the end of a voting session, but at any stage during voting and subsequently as well.

At the end of a voting session, the total scores on the tapes at the present invention, located at the various polling booths, could be machine read and either saved on similar paper tapes or on memory Devices. The coded scores could be password protected, as well as date and time locked. The coded scores could be transmitted to a central counting station, for counting and declaring the results, as and when required.

Thermal Paper. As discussed above, thermal paper printing or thermal transfer printing would be suitable. However, direct thermal print generally fades in a short time. This shortcoming could be overcome by using special thermal paper. Some brands claim print life up to 25 years. However, thermal papers of seven years print life are available and would be suitable for the present application.

In case permanent print is required, then “Thermal Transfer” printing would be suitable. The printed areas on the ribbons become transparent, by transferring the ink onto the paper tapes. Hence, the printed areas would be very clearly visible, with backlighting, for visual verification by voters.

In this case, tinted glass could be fitted on top of the printed area, on the Panel 100, to prevent the printed matter being visible without being backlit.

Dummy Displays. Dummy displays could be provided at polling booths, so that the voters could ascertain whether or not the correct list has been fetched. In not, timely actions could be taken. Besides this, they would also familiarize themselves with the display. This could minimise voting time and voting mistakes.

Motion Detectors and Counter. A motion detector or turnstile is installed at the entrance and another at the exit of a VMU 200, to sense and count the number of people who had voted at a particular VMU 200.

It is activated by the booth officials, through the Booth Server 225, to admit a voter to a VMU 200.

An identification means could also be provided at the at entrance.

Once a voter is identified and then crosses the entrance, the respective candidates' list is displayed on the Display 203.

The Motion Server/Turnstile signals “Voting in Progress” signal to the Booth Server 225.

The voter votes and exits.

At the exit, the motion sensor signals “Voted” signal to the Booth Processor 225.

The next voter may now be admitted.

A counter counts the number of voters who have voted.

The information could be displayed wherever required for public information.

The count can also be tallied with the voting records of the booth.

Instead of two sensors, even a single sensor could be installed at a VMU. The above actions are performed by it, but the two sensors would be the preferred option.

I claim:

1. A voting machine comprising:
a voting machine unit (100) having a control unit (201) connected to a display (203), a touchscreen (205), a memory device ( ), and a printer (207);
wherein the printer prints (207) on a printable medium vote information (107) representing votes entered by voters using the touchscreen (205), the votes being input to the control unit (201) from the touchscreen (205) and the control unit (201) responding to the input votes to control the printing of the vote information (107) by the printer (207);
wherein the printable medium is a roll of paper material of a predetermined width; and
wherein the printer (207) prints successive ones of the vote information (107) adjacent one another along a length and across the width of the paper material.

2. The voting machine according to claim 1 wherein the memory device ( ) has stored therein firmware, a software computer operating system, programs, applications and instructions for operating the control unit and wherein the memory device ( ) further has stored therein voting data including discrete files, one of the files for each constituency and containing names of candidates, associated election symbols, political party affiliations and identification codes.

3. The voting machine according to claim 2 wherein the memory device ( ) is a first memory device and including a second memory device connected to the control unit and having stored therein a copy of the voting data, as a template, for verification of the votes cast.

4. The voting machine according to claim 3 including at least one of:
wherein the voting data stored on the first memory device and the copy of the voting data stored on the second memory devices are installed at different facilities;
wherein the voting data stored on the first memory device and the copy of the voting data stored on the second memory devices are write protected and security sealed;
wherein the first and second memory devices ( ) are write protected; and
wherein the first and second memory devices ( ) are one time programmable devices.

5. The voting machine according to claim 1 wherein the touchscreen (205) is superposed on the display (203).

6. The voting machine according to claim 1 wherein the printer (207) is positioned so that the vote information generated by a voter using the voting machine is visible through a glass pane at a voting panel (100) having the display (203) and the touchscreen (205).

7. The voting machine according to claim 6 including a camera (209) recording an image of the vote information and wherein the control unit (201) compares the image with the vote entered on the touchscreen (205) and cancels the entered vote when the image does not match the vote entered.

8. The voting machine according to claim 7 wherein the printer (207) prints the image on the paper material with the vote information.

9. The voting machine according to claim 1 including a dongle (211) connected to the control unit (201) wherein as a voter votes, an ID of the voter, in encrypted format, is generated by the control unit (201) and is messaged directly to a remote election server (237) in an election network 235 using the dongle (211) thereby updating an electoral roll.

10. The voting machine according to claim 1 including a dongle (211) connected to a booth control unit (230) of a booth server (225), wherein as a voter votes, an ID of the voter, in encrypted format, is generated by the control unit (201) to the booth control unit (230) and is messaged directly to a remote election server (237) in an election network 235 using the dongle (211) thereby updating an electoral roll.

11. The voting machine according to claim 1 including a dongle (211) connected to one of the control unit (201) and a booth control unit (230) for receiving voting data including names of candidates, associated election symbols, political party affiliations and identification codes, the control unit using the voting data to generate at least one of the candidate names and the associated election symbols on the display (203).

12. The voting machine according to claim 1 including a booth server (225) connected to the control unit (201) and communicating with an election server (237) in an election network (235) for verifying identities of the voters to enable the voters to use the touchscreen (205) to vote.

13. The voting machine according to claim 12 including a booth control unit (230) connected between the control unit (201) and the booth server (225) wherein the control unit (201) transmits an ID of each identified voter to the booth server (225) through the booth control unit (230).

14. The voting machine according to claim 13 wherein the display (203) is a first display (203) and including a second display (204) associated with the touchscreen (205) and being connected to at least one of the control unit (201) and the booth control unit (230), and wherein voting data is displayed on the first display (203).

15. A booth area network (500) including a plurality of the voting machine according to claim 1 connected to a booth processor (230) and wherein the voting machines share the printer (207).

16. An absentee voting unit (245) comprising: a sealed container (222) enclosing a voting machine control unit (201) connected to a printer (207) and a camera (209); a booth processor (230) connected to the control unit (201) and to a booth server (225); a voter verification unit (241) connected to the booth server (225), connected to the control unit (201) through a switch (243) and connected to the booth server (225) through the switch (243); and wherein a voter votes using the voter verification unit (241) through a remote connection.
